(19) United States
(12) Patent Application Publication
(10) Pub. No.: US 2024/0311002 A1
(43) Pub. Date: Sep. 19, 2024

(54) SCALING MANAGEMENT APPARATUS AND SCALING MANAGEMENT METHOD FOR STORAGE SYSTEM INCLUDING STORAGE NODES

(71) Applicant: Hitachi, Ltd., Tokyo (JP)

(72) Inventors: Shinichi HAYASHI, Tokyo (JP); Yoshinori OHIRA, Tokyo (JP); Katsuto SATO, Tokyo (JP)

(73) Assignee: Hitachi, Ltd., Tokyo (JP)

(21) Appl. No.: 18/461,065

(22) Filed: Sep. 5, 2023

(30) Foreign Application Priority Data
Mar. 15, 2023 (JP) 2023-041249

(51) Int. Cl. G06F 3/06

(52) U.S. Cl. CPC G06F 3/0608; G06F 3/0644; G06F 3/0673

(57) ABSTRACT

Each of one or a plurality of storage nodes included in a storage system includes a volume provided to a compute and a component that can affect performance of the volume. In a case where a computer determines that a load of a component in any of the one or plurality of storage nodes increased, decreased, increases, or decreases due to the fact that a load of an existing volume in the storage node increased, decreased, increases, or decreases, the computer selects vertical scaling as a scaling method for the storage system, and/or in a case where the computer determines that a load of a component in any of the one or plurality of storage nodes increased, decreased, increases, or decreases due to the fact that the number of volumes in the storage node increased, decreased, increases, or decreases, the computer selects horizontal scaling as a scaling method for the storage system.

### BACKGROUND OF THE INVENTION

### 1. Field of the Invention

The present invention relates generally to scaling of a storage system.

### 2. Description of the Related Art

With the advent of a storage system as a pay-per-use cloud service, allocating only necessary resources to the storage system according to a load when necessary eliminates the need for sizing according to a peak load, and reduces infrastructure cost.

Also for a storage system (hereinafter referred to as an SDS system) as software-defined storage (SDS), it is necessary to appropriately allocate resources to the storage system according to a varying load. Resource allocation to the SDS system includes vertical scaling and horizontal scaling. The “vertical scaling” is to increase or decrease a resource of a storage node forming the SDS system. Increasing the resource is referred to as “scale-up”, and decreasing the resource is referred to as “scale-down”. The “horizontal scaling” is to increase or decrease the number of storage nodes forming the SDS system. Increasing the number of nodes is referred to as “scale-out”, and decreasing the number of nodes is referred to as “scale-in”. Features of the vertical scaling are that it is not necessary to change a setting of a compute (for example, a physical or virtual computer) that accesses the SDS system, and that it is possible to increase or decrease the performance of an existing volume in a short time. A feature of the horizontal scaling is that a range affected at the time of a node failure or a node overload can be localized by increasing the number of nodes.

In Japanese Patent No. 5378946, in a case where an available resource is present in a physical server on which a virtual server under a load balancer operates, the virtual server is scaled up.

### SUMMARY OF THE INVENTION

When a load balancer is used, the load balancer may be overloaded, and thus vertical scaling or horizontal scaling of the load balancer itself is required.

Therefore, it is conceivable to perform scaling without a load balancer.

However, when horizontal scaling is performed in a case where a load balancer is not used, it may be necessary to change a setting of a compute along with volume rearrangement. When only vertical scaling is repeatedly performed in order to avoid a change in the setting of the compute, a range affected at the time of a node failure or a node overload may spread.

Each of one or a plurality of storage nodes included in a storage system includes a volume provided to a compute and a component that can affect performance of the volume. In a case where a computer determines that a load of a component in any of the one or plurality of storage nodes increased, decreased, increases, or decreases due to the fact that a load of an existing volume in the storage node increased, decreased, increases, or decreases, the computer selects vertical scaling (for increasing or decreasing a resource allocated to the storage node having the component without increasing or decreasing the number of storage nodes of the storage system) as a scaling method for the storage system, and/or in a case where the computer determines that a load of a component in any of the one or plurality of storage nodes increased, decreased, increases, or decreases due to the fact that the number of volumes of the storage node was increased or decreased or is increased or decreased, the computer selects horizontal scaling (for increasing or decreasing the number of storage nodes in the storage system) as a scaling method for the storage system.

It is possible to appropriately implement at least one of the elimination of the need for a change in a setting of the compute and the localization of a range affected at the time of a node failure or a node overload.

### BRIEF DESCRIPTION OF THE DRAWINGS

FIG. 1 illustrates an example of a configuration of an overall system according to a first embodiment;

FIG. 2 illustrates an example of a compute node 2;

FIG. 3 illustrates an example of a storage node 4;

FIG. 4 illustrates an example of storage configuration information 26;

FIG. 5 illustrates an example of storage node performance information 27;

FIG. 6 illustrates an example of volume performance information 28;

FIG. 7 illustrates an example of component utilization information 42;

FIG. 8 illustrates an example of scaling information 43;

FIG. 9 illustrates an example of node size information 44;

FIG. 10 illustrates an example of proper threshold value information 45;

FIG. 11 illustrates an example of a relationship between a storage cluster 3, redundant groups 141, and storage nodes 4;

FIG. 12 illustrates an example of a procedure of a scaling selection process;

FIG. 13 illustrates an example of a procedure of a scale-up process;

FIG. 14 illustrates an example of a procedure of a scale-out process;

FIG. 15 illustrates an example of a scale-up proposal screen 361;

FIG. 16 illustrates an example of a scale-out proposal screen 371;

FIG. 17 illustrates an example of a relationship between zones, redundant groups, and storage nodes 141; and

FIG. 18 illustrates an example of drive access information 46.

### DESCRIPTION OF THE PREFERRED EMBODIMENTS

In the following description, an “interface device” may be one or more interface devices. The one or more interface devices may be at least one of devices described below.
The devices include one or more input/output (I/O) interface devices. Each of the one or more input/output (I/O) interface devices is an interface device for at least one of an I/O device and a remote display computer. The I/O interface device for the display computer may be a communication interface device. The at least one I/O device may be any of user interface devices, for example, input devices such as a keyboard and a pointing device, and an output device such as a display device.
The devices include one or more communication interface devices. The one or more communication interface devices may be one or more communication interface devices of the same type (for example, one or more network interface cards (NIC)) or two or more communication interface devices of different types (for example, an NIC and a host bus adapter (HBA)).

In the following description, a “memory” is one or more memory devices that are an example of one or more storage devices, and may typically be a main storage device. At least one of the one or more memory devices as the memory may be a volatile memory device or a nonvolatile memory device.

In addition, in the following description, a “persistent storage device” may be one or more persistent storage devices that are an example of one or more storage devices. Typically, the persistent storage device may be a nonvolatile storage device (for example, an auxiliary storage device), and specifically, for example, may be a hard disk drive (HDD), a solid state drive (SSD), a nonvolatile memory express (NVME) drive, or a storage class memory (SCM).

In the following description, a “processor” may be one or more processor devices. At least one of the one or more processors devices may typically be a microprocessor device such as a central processing unit (CPU), but may be another type of processor device such as a graphics processing unit (GPU). At least one of the one or more processor devices may be a single-core processor device or a multi-core processor device. At least one of the one or more processor devices may be a processor core. At least one of the one or more processor devices may be a processor device in a broad sense, such as a circuit (for example, a field-programmable gate array (FPGA), a complex programmable logic device (CPLD), or an application specific integrated circuit (ASIC)) that is an aggregate of gate arrays in a hardware description language that performs a part or all of processing.

In addition, in the following description, a function may be described using an expression of “yyy function”, but the function may be implemented by executing one or more computer programs by a processor, may be implemented by one or more hardware circuits (for example, FPGA or ASIC), or may be implemented by a combination thereof. In a case where the function is implemented by executing the one or more computer programs by the processor, predetermined processing is appropriately performed using the storage device and/or the interface device, and thus, the function may be at least a part of the processor. Processing described with the function as the subject may be processing performed by the processor or a device including the processor. The one or more computer programs may be installed from a program source. The program source may be, for example, a program distribution computer or a computer-readable recording medium (for example, a non-transitory recording medium). The description of each function is an example, and a plurality of functions may be integrated into one function or one function may be divided into a plurality of functions. The “yyy function” may be referred to as a “yyy unit”.

In addition, in the following description, a “volume” (VOL) indicates a storage area of storage, and may be implemented by a physical storage device or a logical storage device. In addition, the VOL may be a physical VOL or a virtual VOL (VVOL). An “RVOL” may be a VOL based on a physical storage resource included in a storage node having the RVOL. The “VVOL” may be any of an externally connected VOL (EVOL), a capacity expansion VOL (TPVOL), and a snapshot VOL. The EVOL is based on a storage space (for example, a VOL) of an external storage, and may be a VOL according to a storage virtualization technology. The TPVOL may be a VOL including a plurality of virtual areas (virtual storage areas) and conforming to a capacity virtualization technology (typically, thin provisioning). The snapshot VOL may be a VOL as a snapshot of the VOL.

In addition, in the following description, in a case where the same kind of elements are described without being distinguished, a common sign among reference signs may be used, and in a case where the same kind of elements are described while being distinguished, reference signs may be used.

### First Embodiment

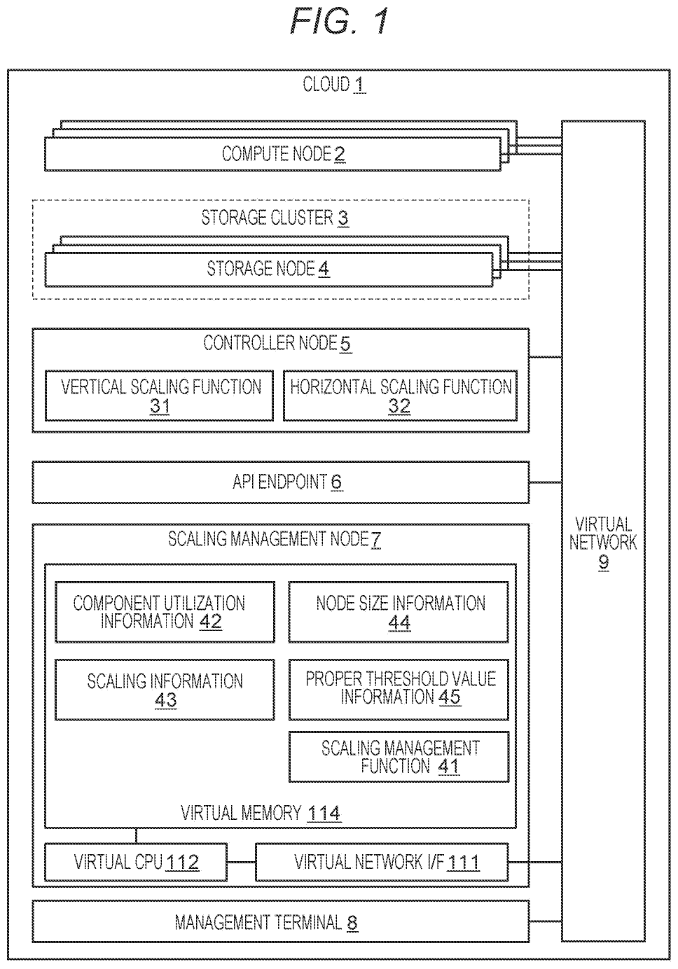

FIG. 1 illustrates an example of a configuration of an overall system according to a first embodiment.

The system is built on a cloud 1. The cloud 1 may be a public cloud or a private cloud. The public cloud is a cloud used by an unspecified number of companies and organizations. The private cloud is a cloud used only by a specific company or organization. The cloud 1 is based on a physical computer system (for example, a plurality of physical computers having a plurality of physical calculation resources).

The system includes one or a plurality of compute nodes 2, one or a plurality of storage nodes 4, a controller node 5, an API endpoint 6, a scaling management node 7, a management terminal 8, and a virtual network 9.

The compute node 2 is a virtual machine that operates on the cloud 1, and is a node that writes data to a volume of the one or plurality of storage nodes 4 and reads data from the volume of the one or plurality of storage nodes 4. The compute node 2 may be present outside the cloud 1 or may be a physical computer.

Each of the one or plurality of storage nodes 4 is a virtual machine that operates on the cloud 1, and is a node that reads/writes data in response to a request from the compute node 2. The one or plurality of storage nodes 4 constitute a storage cluster 3. The storage cluster 3 is an example of a storage system. The storage cluster 3 is an SDS system and includes the one or plurality of storage nodes 4.

The controller node 5 is a node for accessing the API endpoint 6. The controller node 5 includes a vertical scaling function 31 and a horizontal scaling function 32. The vertical scaling function 31 is a function of increasing or decreasing a resource amount of each of the one or plurality of storage nodes 4 in the same storage cluster 3, that is, a function of performing vertical scaling. The horizontal scaling function 32 is a function of adding a new storage node 4 to the same storage cluster 3 or deleting a storage node 4 in the same storage cluster 3, that is, a function of performing horizontal scaling.

The API endpoint 6 is an application programming interface (API) for controlling resources on the cloud.

The scaling management node 7 is a node that manages the scaling of the storage cluster 3. The scaling management node 7 is a virtual machine and includes a virtual network I/F 111, a virtual memory 114, and a virtual CPU 112. The virtual network I/F 111 is a virtual resource to which a physical interface device is allocated, and performs communication via the virtual network 9. The virtual memory 114 (an example of a storage device) is a virtual resource to which a physical memory is allocated, and includes, for example, component utilization information 42, scaling information 43, node size information 44, and proper threshold value information 45. The virtual CPU 112 (an example of a processor) is a virtual resource to which a physical CPU is allocated, and implements a scaling management function 41 by executing a computer program. Note that the scaling management node 7 may be a physical device, and physical resources (physical interface device, physical storage device, and physical processor) may be adopted instead of the virtual network I/F 111, the virtual memory 114, and the virtual CPU 112. The scaling management node 7 may be present outside the cloud 1. In addition, the scaling management node 7 may have at least one of the vertical scaling function 31 and the horizontal scaling function 32.

The management terminal 8 is a terminal for a user (for example, an administrator) to confirm contents proposed by the scaling management node 7 and give an instruction to execute scaling. The management terminal 8 may not be provided, and a scaling method selected by the scaling management node 7 may be performed by the controller node 5.

The virtual network 9 is a virtual resource to which a physical network is allocated, and is a network for connecting the one or plurality of compute nodes 2, the one or plurality of storage nodes 4, the controller node 5, the API endpoint 6, the scaling management node 7, and the management terminal 8 to each other.

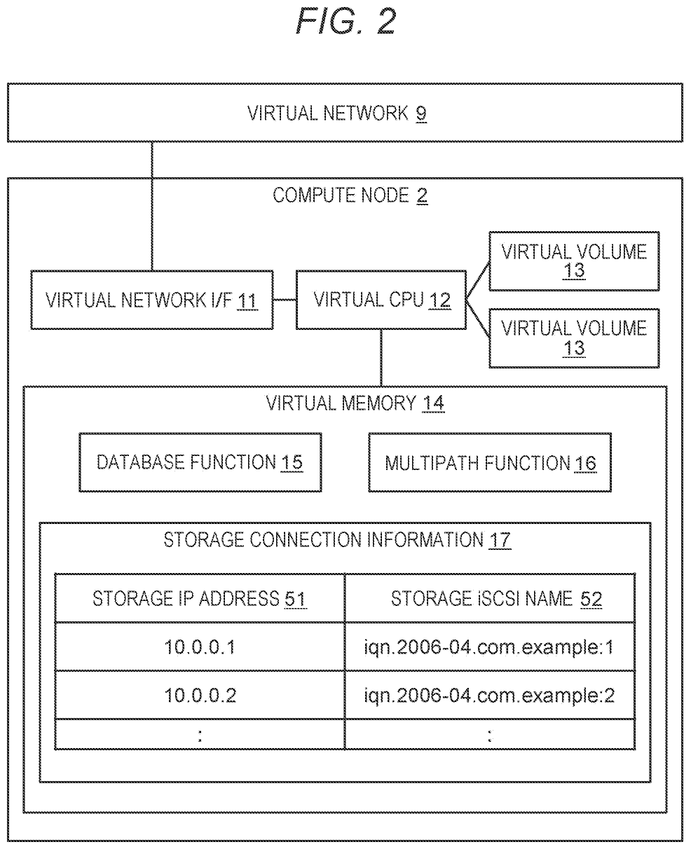

FIG. 2 illustrates an example of the compute node 2. The compute node 2 includes a virtual network I/F 11, a virtual CPU 12, a virtual volume 13 (an example of a volume), and a virtual memory 14.

The virtual network I/F 11 is a virtual interface for connecting to the virtual network 9.

The virtual CPU 12 is a virtual CPU that executes functions on the virtual memory 14.

The virtual volume 13 is a virtual volume for storing data. By writing data to the virtual volume 13, the data can be written to any of the one or plurality of storage nodes 4. By reading data from the virtual volume 13, the data can be read from any of the one or plurality of storage nodes 4.

The virtual memory 14 is a virtual memory that stores the functions executed by the virtual CPU 12 and data required by the functions. The virtual memory 14 includes a database function 15, a multipath function 16, and storage connection information 17.

The database function 15 is a function of managing data, and stores the data to be managed to the one or plurality of storage nodes 4. Instead of or in addition to the database function 15, another function of reading/writing data from/to a virtual volume 23 may be provided. The multipath function 16 is a function of connecting to a certain virtual volume on the storage cluster 3 via the plurality of storage nodes 4 so that access can be continued even when a failure occurs in a certain storage node. The multipath function 16 provides virtual volumes connected via different paths to the database function 15 as one virtual volume. The storage connection information 17 is information used to connect to the storage. The storage connection information 17 includes a storage IP address 51 and a storage iSCSI name 52. The storage IP address 51 indicates the IP address of any of the one or plurality of storage nodes. The storage iSCSI name 52 indicates a name of a target of the storage.

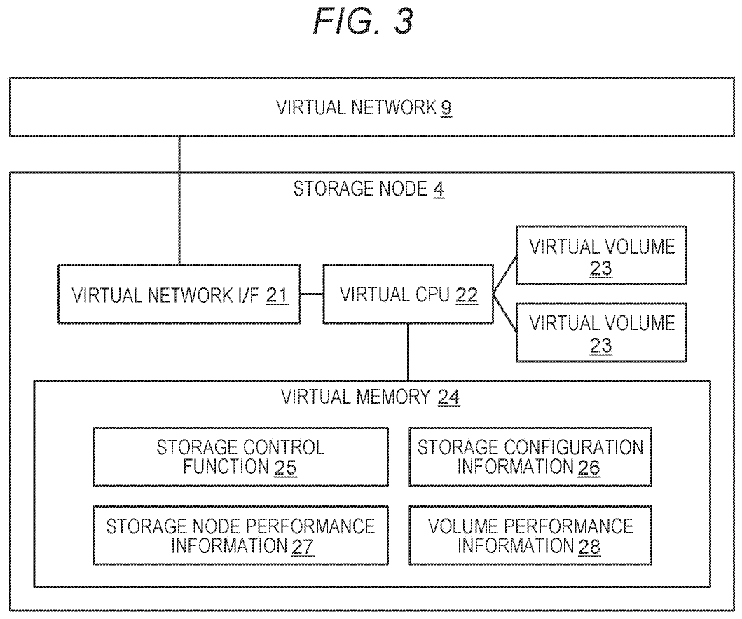

FIG. 3 illustrates an example of the storage node 4.

Each of the one or plurality of storage nodes 4 includes a virtual network I/F 21, a virtual CPU 22, a virtual volume 23, and a virtual memory 24.

The virtual network I/F 21 is a virtual interface for connecting to the virtual network 9.

The virtual CPU 22 is a virtual CPU that executes functions on the virtual memory 24.

The virtual volume 23 is a virtual volume that stores data and is a service provided by the cloud 1. For example, the virtual volume 23 may be provided to and recognized by the compute node 2. The virtual volume 23 recognized by the compute node 2 may be managed as the virtual volume 13 in the compute node 2. That is, when reading from the virtual volume 13 or writing to the virtual volume 13 occurs in the compute node 2, a request for reading or writing (request designating the virtual volume 23) is transmitted to the storage node 4, and a storage control function 25 of the storage node 4 may perform reading from the designated virtual volume 23 or writing to the designated virtual volume 23 in response to the request.

The virtual memory 24 includes the storage control function 25, storage configuration information 26, storage node performance information 27, and volume performance information 28.

The storage control function 25 is a function of writing data to the virtual volume 23 on the storage node 4 of the same storage cluster 3 as the virtual volume 23 based on a write request from the compute node 2, reading data from the virtual volume 23 or the virtual volume 23 on the storage node 4 of the same storage cluster based on a read request, and returning the results to the compute node 2. Even when the storage node 4 is stopped, the storage control function 25 is redundant so that the storage control function 25 of another storage node 4 can take over the function. In addition, the storage control function 25 writes data to the virtual volume 23 in the same storage node 4 and the virtual volume 23 in another storage node 4 so that the data can be accessed even when the storage node 4 is stopped.

The storage configuration information 26 is configuration information of the storage node 4 of the same storage cluster 3.

The storage node performance information 27 is performance information of the storage node 4 of the same storage cluster 3.

The volume performance information 28 is performance information of the virtual volume 23 of the same storage cluster 3.

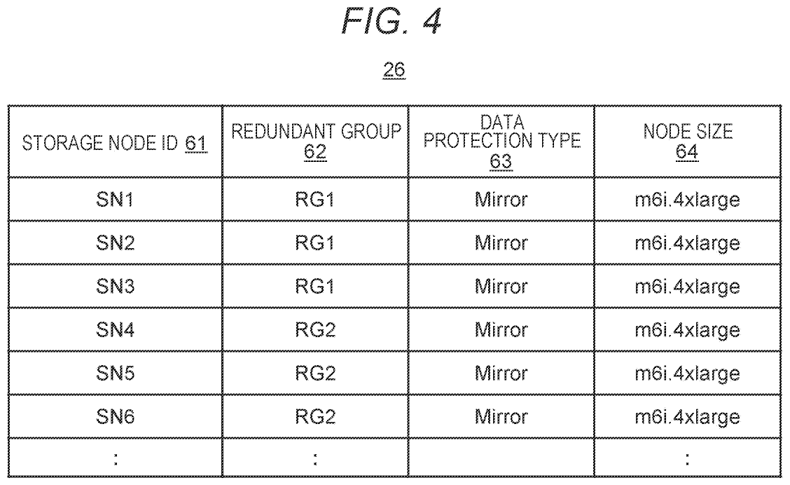

FIG. 4 illustrates an example of the storage configuration information 26.

The storage configuration information 26 includes information such as a storage node ID 61, a redundant group 62, a data protection type 63, and a node size 64 for each storage node 4.

The storage node ID 61 indicates an ID of the storage node 4. The redundant group 62 indicates an ID of a redundant group to which the storage node 4 belongs. The data protection type 63 indicates a type of data protection. When the data protection type 63 indicates “mirror”, data is stored in two storage nodes. When the data protection type 63 indicates “mDnP” (m and n are integers), data is stored in m storage nodes 4, and parity data is stored in n storage nodes 4. The data protection may be implemented by, for example, erasure coding (EC) or redundant arrays of inexpensive disks (Redundant Array of Independent (or Inexpensive) Disks). The node size 64 indicates the size of the storage node 4.

In the following description, an element e having an ID “X” may be referred to as “eX” (that is, the ID may be used instead of the reference sign). According to the example illustrated in FIG. 4, storage nodes SN1 to SN3 form the same redundant group RG1, data written to the storage node SN1 is mirrored to the storage node SN2, data written to the storage node SN2 is mirrored to the storage node SN3, and data written to the storage node SN3 is mirrored to the storage node SN1.

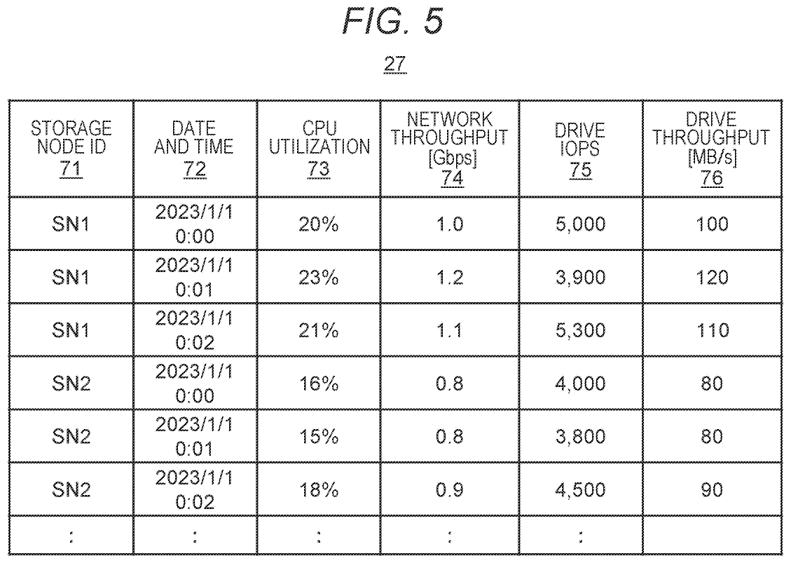

FIG. 5 illustrates an example of the storage node performance information 27.

The storage node performance information 27 includes information such as a storage node ID 71, a date and time 72, CPU utilization 73, a network throughput 74, drive IOPS 75, and a drive throughput 76 for each piece of the acquired node performance information (for example, for each piece of the node performance information acquired by the storage control function 25). “IOPS” is an abbreviation for IO Per Second.

The storage node ID 71 indicates an ID of the storage node 4 from which the node performance information was acquired. The date and time 72 indicates a date and time when the node performance information was acquired.

The CPU utilization 73 indicates CPU utilization (the utilization of the virtual CPU 22) indicated by the node performance information. The network throughput 74 indicates a network throughput (amount of data transmitted and received per unit time by the virtual network I/F 21 through the virtual network 9) indicated by the node performance information. The drive IOPS 75 indicates drive IOPS (number of accesses (number of IOs) to all virtual volumes 23 in the storage node 4 per unit time) indicated by the node performance information. The drive throughput 76 indicates a drive throughput (the amount of data (access throughput) input to and output from all the virtual volumes 23 in the storage node 4 per unit time) indicated by the node performance information.

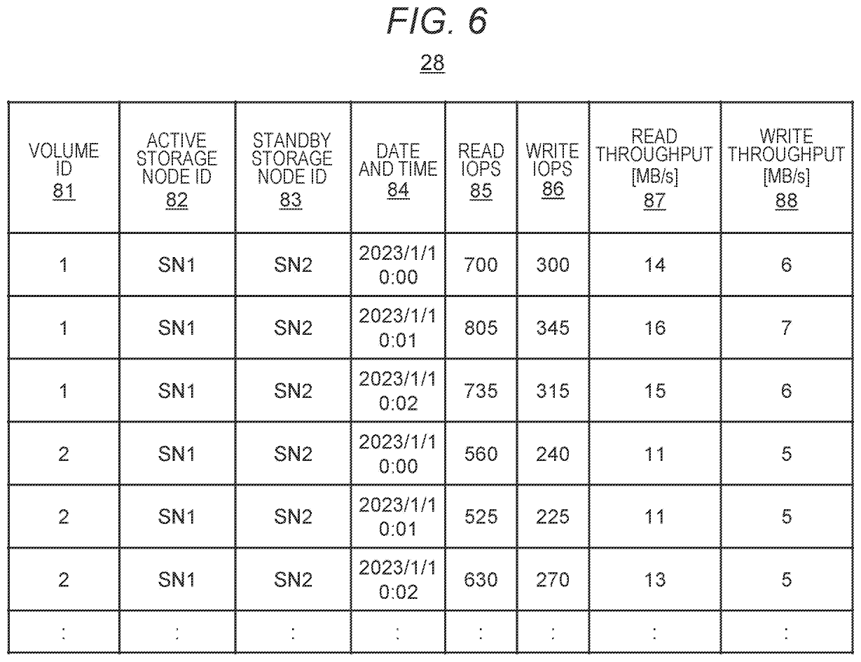

FIG. 6 illustrates an example of the volume performance information 28.

The volume performance information 28 includes information such as a volume ID 81, an active storage node ID 82, a standby storage node ID 83, a date and time 84, read IOPS 85, write IOPS 86, a read throughput 87, and a write throughput 88 for each piece of the acquired volume performance information (for example, for each piece of the volume performance information acquired by the storage control function 25).

The volume ID 81 indicates an ID of a virtual volume 23. The active storage node ID 82 indicates an ID of a storage node in charge of processing of the virtual volume 23. Data written from the compute node 2 is written to the virtual volume 23 in the active storage node 4. The standby storage node ID 83 indicates an ID of a storage node 4 in charge of processing of the virtual volume 23 which the active storage node 4 has been in charge of when the active storage node 4 is stopped. The data written from the compute node 2 is also written to a virtual volume 23 in the standby storage node 4. The date and time 84 indicates a date and time when the volume performance information was acquired.

The read IOPS 85 indicates read IOPS (the number of reads per unit time by the compute node 2 from the virtual volume 23) indicated by the volume performance information. The write IOPS 86 indicates write IOPS (the number of writes per unit time by the compute node 2 to the virtual volume 23) indicated by the volume performance information. The read throughput 87 indicates a read throughput (throughput (the amount of data read per unit time) when the compute node 2 reads the data from the virtual volume 23) indicated by the volume performance information. The write throughput 88 indicates a write throughput (throughput (the amount of data written per unit time) when the compute node 2 writes the data to the virtual volume 23) indicated by the volume performance information.

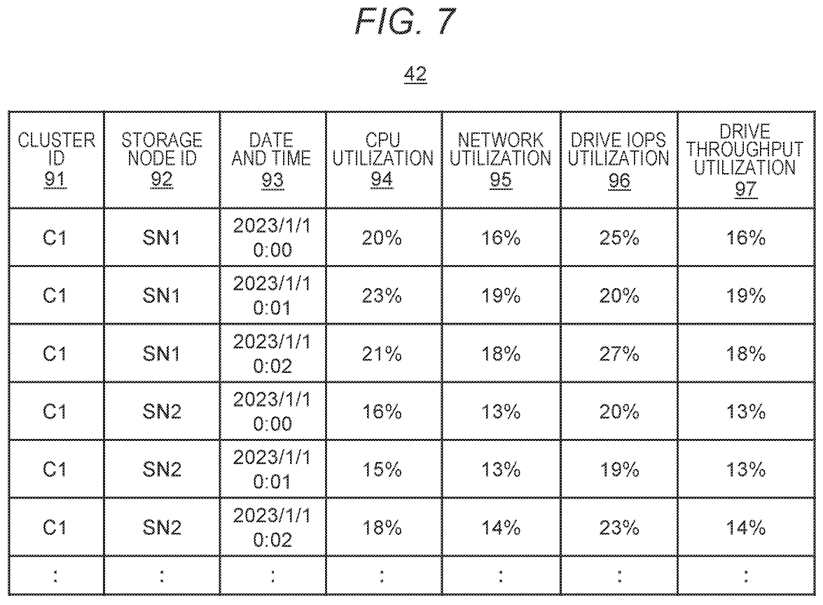

FIG. 7 illustrates an example of the component utilization information 42.

The component utilization information 42 includes, for each acquired component utilization (an example of a component load), information such as a cluster ID 91, a storage node ID 92, a date and time 93, CPU utilization 94, network utilization 95, drive IOPS utilization 96, and drive throughput utilization 97.

The cluster ID 91 indicates an ID of the storage cluster 3. The storage node ID 92 indicates an ID of the storage node 4. The date and time 93 indicates a date and time when the node performance information was acquired. The component utilization can be specified from the node performance information. Examples of the component utilization include CPU utilization, network utilization, drive IOPS utilization, and drive throughput utilization. In the present embodiment, a “component” is an element that can affect the performance of a virtual volume 23 (that is, an element different from the virtual volume 23).

The CPU utilization 94 indicates the utilization of the virtual CPU 22. The network utilization 95 indicates the utilization of the virtual network I/F 21 of the storage node 4. The drive IOPS utilization 96 indicates a ratio of the number of accesses (the number of accesses (drive IOPS) specified from the node performance information) to the maximum number of accesses to all the virtual volumes 23 in the storage node 4. The drive throughput utilization 97 indicates a ratio of the throughput (throughput (drive throughput) specified from the node performance information) to the maximum throughput to all the virtual volumes 23 in the storage node 4. Each of the maximum number of accesses and the maximum throughput may be a predetermined value or a value calculated by a predetermined method.

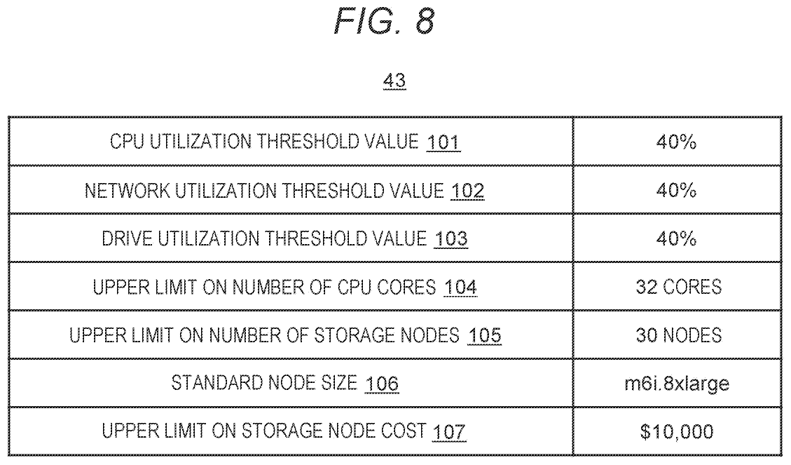

FIG. 8 illustrates an example of the scaling information 43.

The scaling information 43 includes information such as a CPU utilization threshold value 101, a network utilization threshold value 102, a drive utilization threshold value 103, an upper limit 104 on the number of CPU cores, an upper limit 105 on the number of storage nodes, a standard node size 106, and an upper limit 107 on storage node cost.

The CPU utilization threshold value 101 indicates a threshold value for the CPU utilization (the utilization of the virtual CPU 22 of the storage node 4). Scaling is performed when the CPU utilization exceeds this threshold value.

The network utilization threshold value 102 indicates a threshold value for the network utilization (utilization of the virtual network I/F 21 of the storage node 4). Scaling is performed when the network utilization exceeds this threshold value.

The drive utilization threshold value 103 indicates a threshold value for drive utilization (rate of access to all the virtual volumes 23 in the storage node 4). Scaling is performed when the drive utilization exceeds this threshold value.

The upper limit 104 on the number of CPU cores indicates the maximum number of CPU cores that can be scaled up by the storage node 4. The upper limit 105 on the number of storage nodes indicates the maximum number of storage nodes that can be scaled out by the storage cluster 3. The standard node size 106 indicates a size of a storage node used as a standard. The upper limit 107 on storage node cost indicates an upper limit on the cost of the storage node.

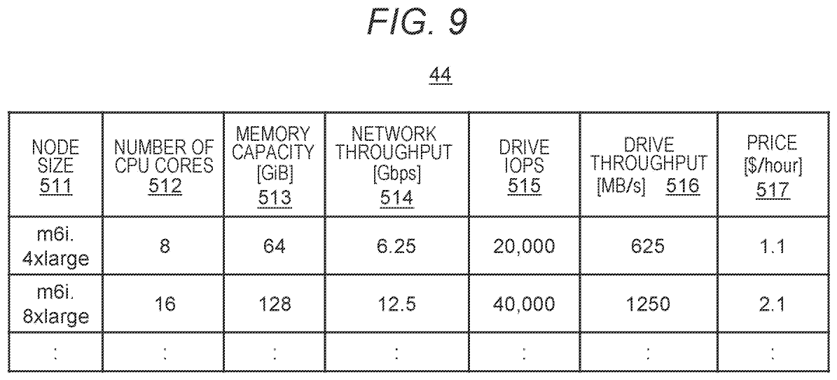

FIG. 9 illustrates an example of the node size information 44.

The node size information 44 includes, for each node size, information such as a node size 511, the number 512 of CPU cores, a memory capacity 513, a network throughput 514, drive IOPS 515, a drive throughput 516, and a price 517.

The node size 511 indicates the size of the node. The number 512 of CPU cores indicates the number of CPU cores allocated to the node. The memory capacity 513 indicates the capacity of a memory allocated to the node. The network throughput 514 indicates an upper limit value of the network throughput allocated to the node. The drive IOPS 515 indicates an upper limit value of the number of accesses to all virtual drives connected to the node. The drive throughput 516 indicates an upper limit value of the throughput of access to all the virtual drives connected to the node. The price 517 indicates a price per hour charged at the time of use of the node.

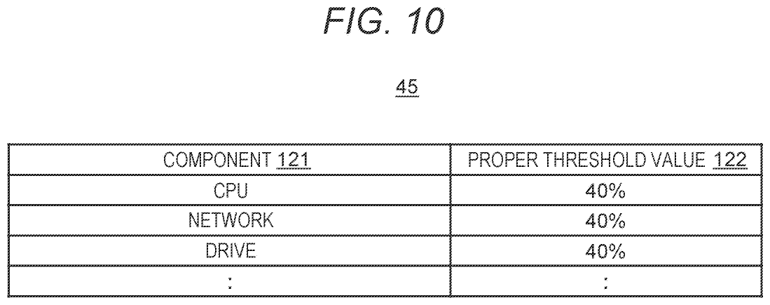

FIG. 10 illustrates an example of the proper threshold value information 45.

The proper threshold value information 45 includes a component 121 and a proper threshold value 122. The component 121 indicates an element that constitutes the storage node 4 and can be a bottleneck of volume performance. The proper threshold value 122 indicates an upper limit value of proper utilization of each component. Note that, in a case where the proper threshold value 122 is the same as the threshold values 101 to 103 in the scaling information 43, the proper threshold value information 45 may not be present, or the threshold values 101 to 103 in the scaling information 43 may not be present. In addition, the proper threshold value 122 may be changed by the management terminal 8. In this case, the proper threshold value 122 may be reflected in the threshold values 101 to 103 in the scaling information 43, and the trigger of the scaling may be changed.

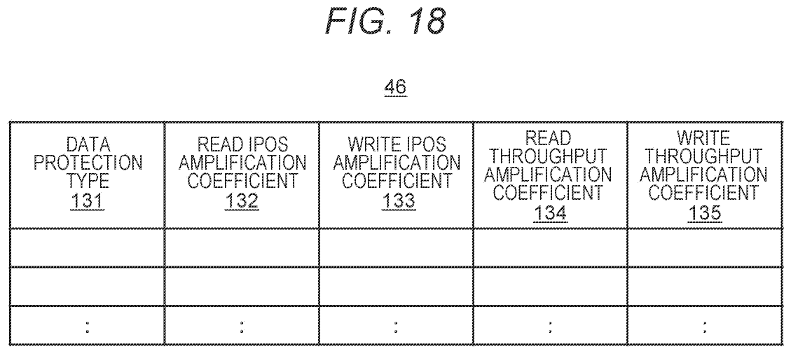

FIG. 18 illustrates an example of the drive access information 46.

The drive access information 46 indicates information such as a data protection type 131, a read IOPS amplification coefficient 132, a write IOPS amplification coefficient 133, a read throughput amplification coefficient 134, and a write throughput amplification coefficient 135 for each data protection type.

The data protection type 131 indicates a data protection type. The read IOPS amplification coefficient 132 indicates an amplification coefficient of read IOPS. The write IOPS amplification coefficient 133 indicates an amplification coefficient of write IOPS. The read throughput amplification coefficient 134 indicates an amplification coefficient of the read throughput. The write throughput amplification coefficient 135 indicates an amplification coefficient of the write throughput.

The drive access information 46 is information in which how many times IOPS or throughput to the virtual volume 23 becomes IOPS or throughput of access from the compute node 2 is recorded for each data protection type for each read and write.

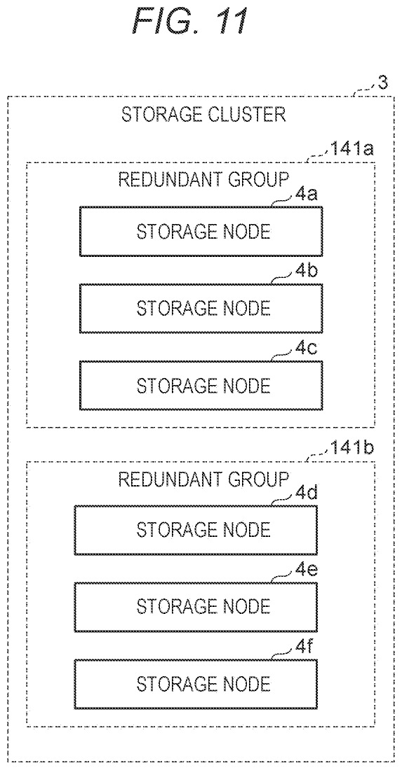

FIG. 11 illustrates an example of a relationship between the storage cluster 3, redundant groups 141, and the storage nodes 4.

The storage cluster 3 includes the plurality of redundant groups 141. Each of the plurality of redundant groups 141 includes two or more storage nodes 4. For each of the plurality of redundant groups 141, data stored in any storage node 4 in the redundant group 141 is made redundant between the storage nodes 4 in the redundant group. Redundancy of data depends on the data protection type 63 (see FIG. 4).

According to the example illustrated in FIG. 11, the storage cluster 3 includes a redundant group 141a and a redundant group 141b. The redundant group 141a includes a storage node 4a, a storage node 4b, and a storage node 4c. The redundant group 141b includes a storage node 4d, a storage node 4e, and a storage node 4f. Each redundant group 141 is a range in which data is made redundant by the storage control function 25.

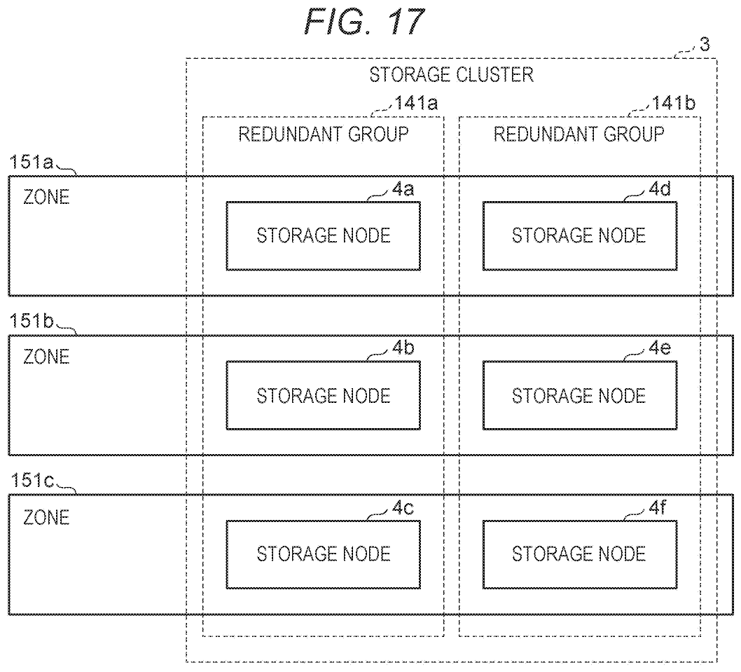

FIG. 17 illustrates an example of a relationship between the storage cluster 3, the redundant groups 141, the storage nodes 4, and zones 151.

The plurality of zones 151 (for example, zones 151a to 151c) that are physically independent of one another are present. Specifically, for example, in each zone 151, a server, a network, a power supply, and the like are independent from any other zone 151, and the storage nodes 4 can continue processing even when a failure occurs in the other zone 151. The plurality of storage nodes 4 in the same redundant group 141 are arranged in the plurality of different zones 151. For example, the storage nodes 4a to 4c constituting the redundant group 141a belong to the zones 151a to 151c, respectively. The zones 151 may be, for example, server racks.

When the data protection type indicates “mirror”, data is stored in two storage nodes 4. In each zone 151, there are no two or more storage nodes 4 in the same redundant group 141, and a plurality of storage nodes 4 in the plurality of different redundant groups 141 belong to the zone 151. Therefore, even if a failure occurs in a certain zone 151 and two or more storage nodes 4 belonging to the zone 151 are stopped, access to data can be continued since the data is made redundant in storage nodes 4 in a zone 151 different from the zone 151 to which the stopped storage nodes 4 belong.

Hereinafter, an example of processing performed in the present embodiment will be described.

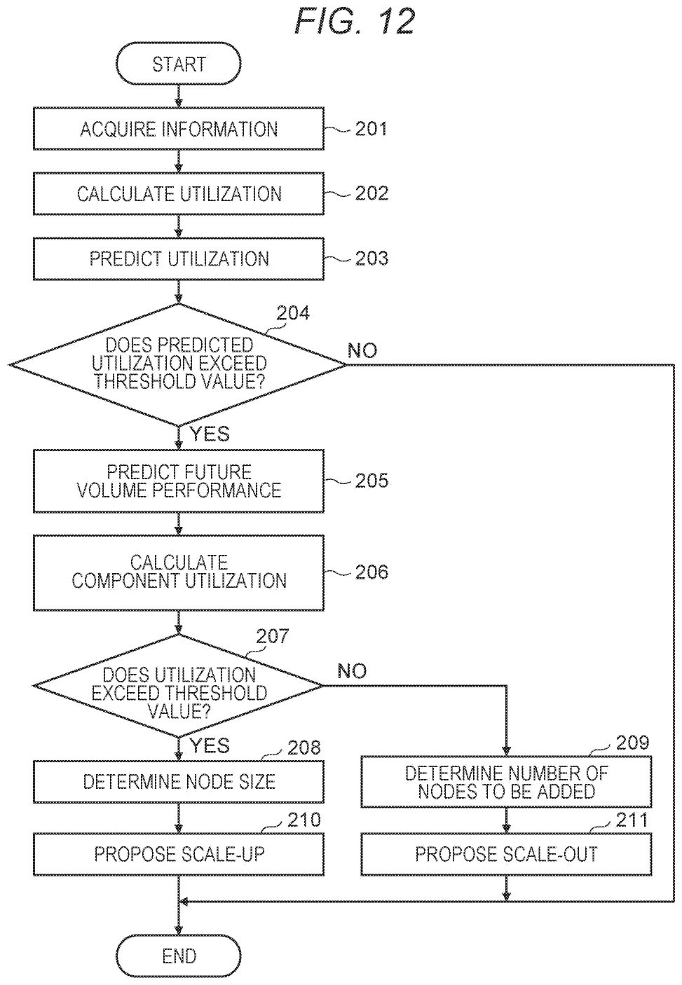

FIG. 12 illustrates an example of a procedure of a scaling selection process.

In the scaling selection process, the scaling management function 41 selects a scaling method and proposes the selected scaling method. The scaling management function 41 may periodically perform the scaling selection process at a frequency such as once a week.

In step 201, the scaling management function 41 acquires the storage configuration information 26, the storage node performance information 27, and the volume performance information 28 from each storage node 4.

In step 202, the scaling management function 41 calculates component utilization (various types of utilization) using the storage node performance information 27 and the node size information 44, and records the component utilization in the component utilization information 42. Specifically, for example, the various types of utilization are calculated using the following equations.

The network utilization 95=the network throughput 74/the network throughput 514

The drive IOPS utilization 96=the drive IOPS 75/the drive IOPS 515

The drive throughput utilization 97=the drive throughput 76/the drive throughput 516

Since the utilization of the virtual CPU 22 can be acquired from each storage node 4, the scaling management function 41 records the acquired CPU utilization 73 as the CPU utilization 94 in the component utilization information 42.

In step 203, the scaling management function 41 predicts future time-series component utilization based on the time-series utilization of each component in the component utilization information 42, and records the result of the prediction in the component utilization information 42. Note that examples of a method of predicting future time-series information based on past time-series information include a method using regression analysis and a method using an autoregressive integrated moving average (ARIMA) model.

In step 204, the scaling management function 41 determines whether or not the future component utilization predicted in step 203 exceeds a threshold value (for example, the scaling management function 41 determines whether or not any type of utilization in the component utilization exceeds the proper threshold value 122 or a threshold value that is among the threshold values 101 to 103 and corresponds to the type of the utilization). For example, the determination is a determination of whether or not the component utilization exceeds a threshold value within a certain period of time in the future (for example, within three months from the present). In a case where the result of the determination is true, the process proceeds to step 205. Otherwise, the process ends.

In step 205, the scaling management function 41 predicts the future time-series read IOPS 85, write IOPS 86, read throughput 87, and write throughput 88 of each virtual volume 23 based on the time-series read IOPS 85, write IOPS 86, read throughput 87, and write throughput 88 of each virtual volume 23 in the volume performance information 28, and records the results of the prediction in the volume performance information 28.

In step 206, the scaling management function 41 calculates, based on the results predicted in step 205, the component utilization determined to exceed the threshold value in step 204. For example, the scaling management function 41 calculates the CPU utilization by the following equations. Note that processing parallelism, a read IOPS processing time, a write IOPS processing time, a read transfer time, and a write transfer time are predetermined values.

The CPU utilization 94=(the read IOPS 85+the write IOPS 86)/the maximum number of accesses

The maximum number of accesses=the processing parallelism/(an access processing time+a data transfer time)

The access processing time=(the read IOPS processing time×the read IOPS 85+the write IOPS processing time×the write IOPS 86)/(the read IOPS 85+the write IOPS 86)

The data transfer time=the read transfer time×the read throughput 87/the read IOPS 85+the write transfer time×the write throughput 88/the write IOPS 86

For example, the scaling management function 41 calculates the network utilization by the following equation.

The network utilization 95=the read throughput 87×the read throughput amplification coefficient 134+the write throughput 88×the write throughput amplification coefficient 135

For example, the scaling management function 41 calculates the drive IOPS utilization by the following equation.

The drive IOPS utilization 96=(the read IOPS 85×the read IOPS amplification coefficient 132+the write IOPS 86×the write IOPS amplification coefficient 133)/the drive utilization threshold value 103

For example, the scaling management function 41 calculates the drive throughput utilization by the following equation.

The drive throughput utilization 97=(the read throughput 87×the read throughput amplification coefficient 134+the write throughput 88×the write throughput amplification coefficient 135)/the drive utilization threshold value 103

In step 207, the scaling management function 41 determines whether or not the component utilization calculated in step 206 exceeds a threshold value (for example, the scaling management function 41 determines whether or not any type of utilization in the component utilization exceeds the proper threshold value 122 or a threshold value that is among the threshold values 101 to 103 and corresponds to the type of the utilization). In a case where the result of the determination is true, the process proceeds to step 208. Otherwise, the process proceeds to step 209.

In step 208, the scaling management function 41 determines a node size to be changed so that the component utilization does not exceed the threshold value (the proper threshold value 122 or the threshold values 101 to 103). Specifically, for example, the scaling management function 41 selects a node size corresponding to a large numerical value of component utilization determined to exceed the threshold value in step 204 from the node size information 44, calculates the component utilization as in step 206, and checks whether or not the component utilization exceeds the threshold value. The scaling management function 41 selects any node size (for example, a node size causing the price 517 to be lowest or the largest node size) among node sizes that do not cause the component utilization to exceed the threshold value.

In step 209, the scaling management function 41 determines, based on the data protection type, the number of nodes to be added. For example, the number of nodes to be added is obtained based on the following equations. For example, when the data protection type indicates “mirror”, the number of nodes to be added may be “3”.

A proper number of nodes=(the current number of storage nodes)×(the threshold value for a component whose utilization exceeds the threshold value in step 204)/(the component utilization exceeding the threshold value in step 204)

The number of nodes to be added=(the minimum integer equal to or larger than the proper number of nodes)−(the current number of storage nodes)

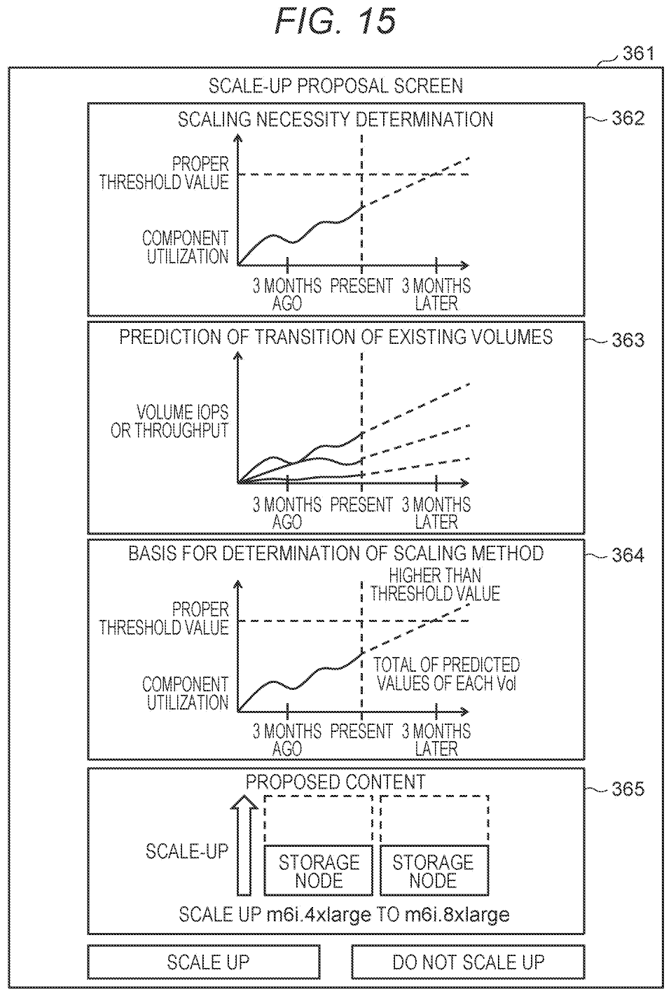

In step 210, the scaling management function 41 proposes the scale-up (for example, a scale-up proposal screen 361 illustrated in FIG. 15 to be described later is displayed on the management terminal 8).

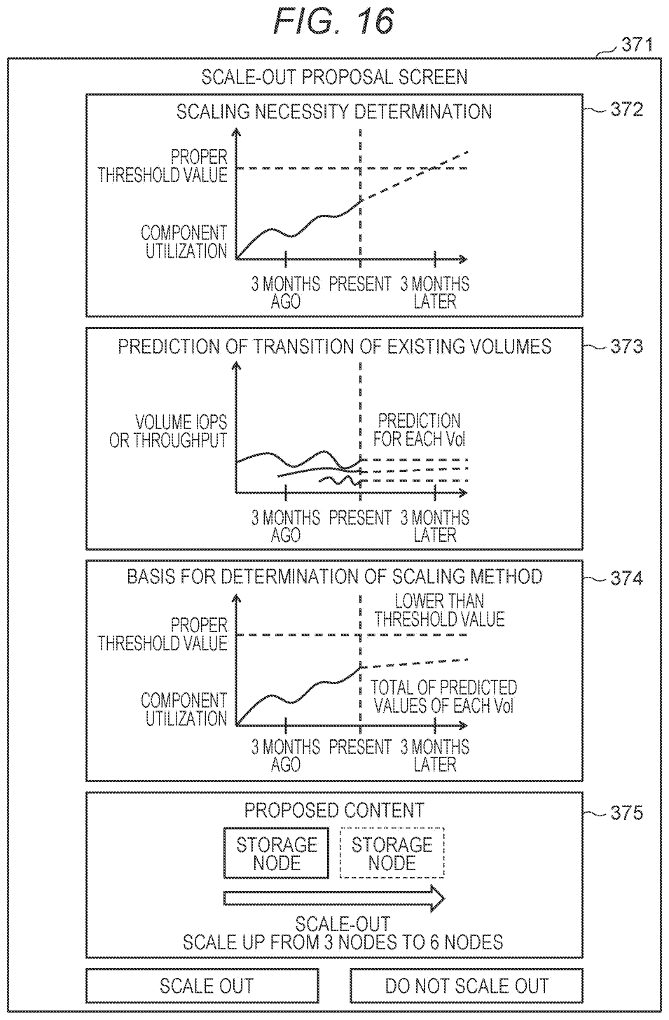

In step 211, the scaling management function 41 proposes the scale-out (for example, a scale-out proposal screen 371 illustrated in FIG. 16 to be described later is displayed on the management terminal 8).

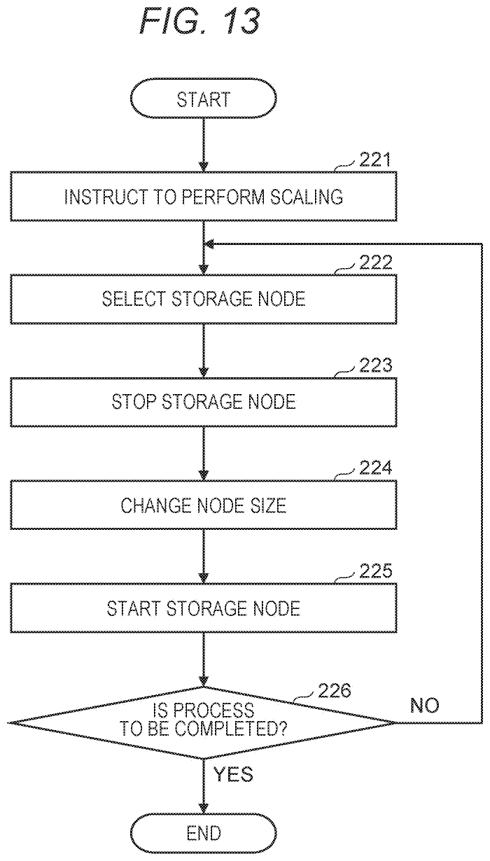

FIG. 13 illustrates an example of a procedure of a scale-up process.

In the scale-up process, the scale-up of the storage node 4 is performed.

In step 221, the scaling management function 41 instructs the vertical scaling function 31 to scale up, to the node size determined in step 208, all the one or plurality of storage nodes 4 in the storage cluster 3 to which the storage node 4 having the component whose utilization exceeds the threshold value in step 204 belongs. As a scale-up target, instead of the storage cluster 3, the scaling management function 41 may designate the redundant group 141 to which the storage node 4 having the component whose utilization exceeds the threshold value belongs, may designate the storage node 4 having the component whose utilization exceeds the threshold value and a standby storage node 4 serving as a pair with the storage node 4, or may designate only the storage node 4 having the component whose utilization exceeds the threshold value. The vertical scaling in units of redundant groups will be described later.

In step 222, the vertical scaling function 31 selects one storage node 4 to be scaled up.

In step 223, the vertical scaling function 31 stops the storage control function 25 of the storage node 4 selected in step 222, and stops the storage node 4.

In step 224, the vertical scaling function 31 instructs the API endpoint 6 to change the storage node 4 stopped in step 223 to the node size indicated in step 221. In response to the instruction, the API endpoint 6 changes the storage node 4 indicated in step 221 to the node size indicated in step 221.

In step 225, the vertical scaling function 31 instructs the API endpoint 6 to start the storage node 4 stopped in step 223. In response to the instruction, the API endpoint 6 starts the storage node 4 indicated in step 225. The vertical scaling function 31 waits until the started storage node 4 starts the storage control function 25 and data that cannot be written out while the storage node 4 is stopped is completely copied from another storage node 4.

In step 231, the vertical scaling function 31 determines whether or not all storage nodes indicated were scaled up. In a case where the result of the determination is true, the process ends. Otherwise, the process returns to step 222.

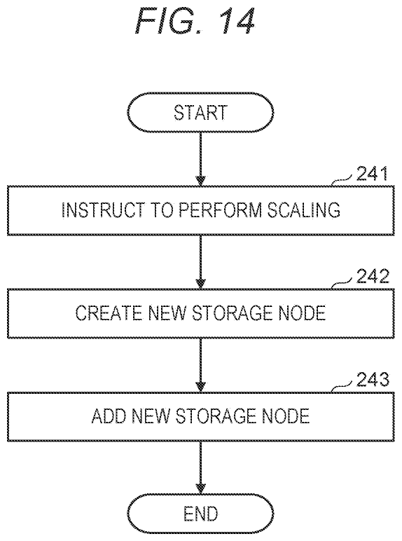

FIG. 14 illustrates an example of a procedure of a scale-out process.

In the scale-out process, the scale-out of the storage cluster 3 is performed.

In step 241, the scaling management function 41 instructs the horizontal scaling function 32 to add the number of nodes determined in step 209 and having the node size defined in the standard node size 106 to the storage cluster 3 to which the storage node 4 of the component whose utilization exceeds the threshold value in step 204 belongs.

In step 242, the horizontal scaling function 32 instructs the API endpoint 6 to create only storage nodes having the node size indicated in step 241 in the number indicated in step 241. The API endpoint 6 creates a storage node 4 based on this instruction.

In step 243, the horizontal scaling function 32 adds the storage node 4 created in step 242 to the storage cluster 3. Specifically, the horizontal scaling function 32 adds information of the storage node 4 created in step 242 to the storage configuration information 26. A redundant group 141 to which the added storage node 4 belongs is newly created unlike the existing redundant groups.

FIG. 15 illustrates an example of the scale-up proposal screen 361.

The scale-up proposal screen 361 is created by the scaling management function 41 in step 210. The scale-up proposal screen 361 includes scaling necessity determination 362, prediction 363 of transition of existing volumes, basis 364 for determination of a scaling method, and proposed content 365. The scale-up proposal screen 361 is displayed on the management terminal 8.

The scaling necessity determination 362 includes a graph indicating the basis for the necessity of scaling, for example, a graph indicating the future time-series component utilization predicted in step 203.

The prediction 363 of transition of existing volumes includes a graph indicating future IOPS and throughput of each existing volume, for example, a graph indicating the future time-series read IOPS, write IOPS, read throughput, and/or write throughput of each volume predicted in step 205.

The basis 364 for determination of a scaling method is a graph indicating the basis for determination of a scaling method, and includes, for example, a graph indicating the future component utilization calculated in step 206.

The proposed content 365 indicates the node size after the scale-up and indicates the node size determined in step 208.

When the user presses a “scale-up” button (for example, when the user clicks or taps the button), the proposal is approved, and the scale-up is performed as proposed (an instruction for implementation of the scale-up is sent from the scaling management function 41 to the vertical scaling function 31).

FIG. 16 illustrates an example of the scale-out proposal screen 371.

The scale-out proposal screen 371 is created by the scaling management function 41 in step 211. The scale-out proposal screen 371 includes scaling necessity determination 372, prediction 373 of transition of existing volumes, basis 374 for determination of a scaling method, and proposed content 375. The scale-out proposal screen 371 is displayed on the management terminal 8.

The scaling necessity determination 372 is the same as the scaling necessity determination 362. The prediction 373 of transition of existing volumes is the same as the prediction 363 of transition of existing volumes. The basis 374 for determination of a scaling method is the same as the basis 364 for determination of a scaling method.

The proposed content 375 indicates the number of nodes after the scale-out and indicates the number of nodes determined in step 209.

When the user presses a “scale-out” button (for example, the user clicks or taps the button), the proposal is approved, and the scale-out is performed as proposed (an instruction for implementation of the scale-out is transmitted from the scaling management function 41 to the horizontal scaling function 32).

### Second Embodiment

A second embodiment will be described. Differences from the first embodiment will be mainly described, and description of points common to the first embodiment will be omitted or simplified (the same applies to a third embodiment).

In the second embodiment, the scaling management function 41 selects a scaling method without predicting future component utilization. Specifically, in step 206, the scaling management function 41 defines an analysis period (for example, a past one month) as a period from the present to a past certain period, and calculates the component utilization in the analysis period except for a virtual volume 23 added in the analysis period. The component utilization is calculated based on performance information of each virtual volume 23 present from the start to the end of the analysis period. In a case where the component utilization exceeds the threshold value as a result of the calculation, the scaling management function 41 selects the scale-up. Otherwise, scaling management function 41 selects the scale-out.

### Third Embodiment

In the third embodiment, the scaling management function 41 selects a scaling method based on the transition in the number of virtual volumes 23. The scaling management function 41 records the number of volumes created after scale-up or scale-out in the past in the virtual memory 114. In step 207, the scaling management function 41 determines whether or not the number exceeds a predetermined threshold value. In a case where the result of this determination is true, the scaling management function 41 selects the scale-out. Otherwise, the scaling management function 41 selects the scale-up.

Although some embodiments have been described above, these are examples for describing the present invention, and it is not intended to limit the scope of the present invention only to these embodiments. For example, any of the storage nodes 4 may also serve as the controller node 5 and/or the scaling management node 7. Furthermore, for example, although a scale-down process is not illustrated, the scale-down process may be performed in substantially the same procedure as the procedure of the scale-up process (the difference between the processes is not an increase in resources allocated to the storage node 4 but a reduction in resources). Furthermore, for example, although a scale-in process is not illustrated, the scale-in process may be performed in substantially the same procedure as the procedure of the scale-out process (the difference is that there is no need to create a storage node and a storage node is reduced).

The above description can be summarized as follows, for example. The following summary may include supplementary description for the above description and description of modifications.

A scaling management apparatus (for example, the scaling management node 7) of a storage system (for example, the storage cluster 3) that includes one or a plurality of storage nodes (for example, the storage node 4) having a volume (for example, the virtual volume 23) provided to a compute (for example, the compute node 2) and a component that can affect performance of the volume and in which a selected scaling method is performed is constructed. “The selected scaling method is implemented” may mean that the scaling method (alternatively, a scaling method selected by the scaling management apparatus, proposed to a user, and approved for the proposal) selected by the scaling management apparatus is implemented automatically (for example, by the scaling management apparatus, the controller node 5, or another device) or manually.

The scaling management apparatus includes a storage device (for example, the virtual memory 144) and a processor (for example, the virtual CPU 112).

The storage device stores component load information (for example, the component utilization information 42) and volume load information (for example, the acquired volume performance information 28). The component load information is information indicating a load (for example, utilization) of a component included in the one storage node or each of the plurality of storage nodes. The volume load information is information indicating a load (for example, performance) of a volume included in the one storage node or each of the plurality of storage nodes.

The processor refers to the component load information and the volume load information. In a case where the processor determines that a load of a component in any of the one or plurality of storage nodes increased, decreased, increases, or decreases due to the fact that a load of an existing volume in the storage node increased, decreased, increases, or decreases, the processor selects vertical scaling (for increasing or decreasing a resource allocated to the storage node having the component without increasing or decreasing the number of storage nodes of the storage system) as a scaling method for the storage system, and/or in a case where the processor determines that a load of a component in any of the one or plurality of storage nodes increased, decreased, increases, or decreases due to the fact that the number of volumes of the storage node was increased or decreased or is increased or decreased, the processor selects horizontal scaling (for increasing or decreasing the number of storage nodes in the storage system) as a scaling method for the storage system.

It is possible to appropriately implement at least one of the elimination of the need for a change in a setting of the compute and the localization of a range affected at the time of a node failure or a node overload. Note that, for example, a change in a setting of the compute at the time of the scale-out may include setting, in the compute, an ID of a volume and/or an ID of a port to which the volume belongs for the volume added or rearranged as the number of nodes increases or decreases.

The processor may determine whether or not a load of a component in any of the one or plurality of storage nodes exceeds a predetermined threshold value (for example, step 204). In a case where the result of the determination is true (for example, in a case where a component whose predicted future load exceeds the threshold value is present (for example, in a case where step 204 is Yes)), the load of each volume of the storage node may be predicted. When the predicted load of each volume of the storage node is on an increasing trend (for example, in a case where the load (predicted future load) of any component exceeds the threshold value based on the predicted future load of each volume (for example, in a case where step 207 is Yes)), the processor may select the scale-up as the vertical scaling. As a result, it is possible to appropriately implement the elimination of the need for a change in a setting of the compute. In addition, when a predicted load of each volume of a storage node having a component whose load exceeds the threshold value is not on an increasing trend (for example, in a case where the load (predicted future load) of any component is equal to or less than the threshold value based on the predicted future load of each volume (for example, in a case where step 207 is No)), the processor may select the scale-out as the horizontal scaling. As a result, it is possible to appropriately implement the localization of a range affected at the time of a node failure or a node overload.

Note that the processor may determine whether or not a load (for example, predicted future load) of a component in any of the one or plurality of storage nodes is less than another threshold value lower than the predetermined threshold value. In a case where the result of the determination is true, the processor may predict a load of each volume of the storage node having the component. When a predicted load of each volume of the storage node is on a decreasing trend (for example, in a case where a load (predicted future load) of any component is less than another threshold value based on a predicted future load of each volume (for example, a threshold value lower than the proper threshold value)), the processor may select the scale-down as the vertical scaling. On the other hand, when the predicted load of each volume of the storage node is not on a decreasing trend (for example, in a case where a load of any component does not become less than the other threshold value based on the predicted future load of each volume), the processor may select the scale-in as the horizontal scaling.

For each of the one or plurality of storage nodes, the processor may calculate a load of a component of the storage node based on a load of each volume present from the start to the end of a past predetermined period (for example, the above-described analysis period) (for example, step 206 may be performed on an existing volume in the past predetermined period without step 205). In a case where the storage node of which the calculated load exceeds the threshold value is present (that is, a component whose load exceeds the threshold value for a reason different from the addition of a volume is present), the processor may select the scale-up of the storage node as the vertical scaling. As a result, it is possible to appropriately implement the elimination of the need for a change in a setting of the compute. Note that the calculation of the load of the component of the storage node on the basis of the load of each volume present from the start to the end of the past predetermined period and the determination of whether or not the load exceeds the threshold value may be performed in a case where the result of the determination as to whether or not a predicted future load of a component in any storage node exceeds the predetermined threshold value is true (for example, in a case where step 204 is Yes). In addition, in a case where no storage node whose calculated load exceeds the threshold value is present, the processor may select the scale-out as the horizontal scaling.

The processor may select the scale-out as the horizontal scaling in a case where a storage node in which the number of volumes added in the past predetermined period exceeds a predetermined threshold value is present. As a result, it is possible to appropriately implement the localization of a range affected at the time of a node failure or a node overload. The “past predetermined period” in this paragraph may be a period from previous selection of a scaling method or the execution of scaling to the present. Therefore, for example, the scaling management function 41 may select a scaling method based on the first embodiment or the second embodiment at least for the first time, and may select a scaling method based on the third embodiment from the next time. As a result, it is possible to appropriately implement the localization of a range affected at the time of a node failure or a node overload while reducing the calculation load of the scaling method selection.

In a case where a storage node in which a load of a component increased, decreased, increases, or decreases due to the fact that a load of an existing volume increased, decreased, increases, or decreases is present, the processor may select the vertical scaling for a redundant group including the storage node among a plurality of redundant groups (for example, the plurality of redundant groups 141) (for example, each storage node belonging to the redundant group may be a target of the vertical scaling). As a result, targets of the vertical scaling can be appropriately narrowed down, and thus, it is possible to more appropriately implement the elimination of the need for a change in a setting of the compute.

In a case where two or more redundant groups for which the vertical scaling is selected are present, the processor may select to perform the vertical scaling on two or more storage nodes belonging to the same zone among the two or more redundant groups in parallel. For example, it is assumed that the storage nodes 4a and 4e are storage nodes having components corresponding to Yes in step 207 (see FIG. 17). In this case, two or more redundant groups for which the scale-up is selected are the redundant groups 141a and 141b. The scaling management function 41 does not select to scale up two or more storage nodes belonging to the different zones 151a to 151c in parallel. The scaling management function 41 selects to scale up two or more storage nodes belonging to the same zone 151 in parallel. Specifically, for example, the storage nodes 4a and 4d belonging to the zone 151a may be scaled up in parallel, then the storage nodes 4b and 4e belonging to the zone 151b may be scaled up in parallel, and finally the storage nodes 4c and 4f belonging to the zone 151c may be scaled up in parallel. That is, the scale-up may be performed on a zone basis, and the scale-up is not performed on two or more zones in parallel. Note that, regarding the scale-down, similarly, two or more storage nodes belonging to the same zone 151 may be scaled down in parallel. In addition, the vertical scaling may be controlled based on selection by the scaling management function 41 (that is, the vertical scaling may be controlled by the scaling management function 41) or may be controlled by the vertical scaling function 31.

What is claimed is:

1. A scaling management apparatus of a storage system that includes one or a plurality of storage nodes each having a volume provided to a compute and a component that can affect performance of the volume, and in which a selected scaling method is performed, the scaling management apparatus comprising:
a storage device; and
a processor, wherein
the storage device stores:
component load information indicating, for each of the one or the plurality of storage nodes, a load of a component included in the storage node; and
volume load information indicating, for each of the one or plurality of storage nodes, a load of a volume included in the storage node, and
the processor is configured to:
refer to the component load information and the volume load information;
in a case where the processor determines that a load of a component in any of the one or plurality of storage nodes increased, decreased, increases, or decreases due to a fact that a load of an existing volume in the storage node increased, decreased, increases, or decreases, select, as a scaling method for the storage system, vertical scaling for increasing or decreasing a resource allocated to the storage node having the component without increasing or decreasing a number of storage nodes of the storage system; and/or
in a case where the processor determines that a load of a component in any of the one or plurality of storage nodes increased, decreased, increases, or decreases due to a fact that a number of volumes of the storage node increased, decreased, increases, or decreases, select, as a scaling method for the storage system, horizontal scaling for increasing or decreasing the number of storage nodes of the storage system.

2. The scaling management apparatus according to claim 1, wherein the processor is further configured to:
determine whether or not a load of a component in any of the one or plurality of storage nodes exceeds a predetermined threshold value;
predict a load of each volume of the storage node in a case where a result of the determination is true; and
select scale-up as the vertical scaling when the predicted load of each volume of the storage node is on an increasing trend.

3. The scaling management apparatus according to claim 1, wherein the processor is further configured to:
determine whether or not a load of a component in any of the one or plurality of storage nodes exceeds a predetermined threshold value;
predict a load of each volume of the storage node in a case where a result of the determination is true; and
select scale-out as the horizontal scaling when the predicted load of each volume of the storage node is not on an increasing trend.

4. The scaling management apparatus according to claim 1, wherein the processor is further configured to:
calculate, for each of the one or plurality of storage nodes, a load of a component of the storage node based on a load of each volume present from a start to an end of a past predetermined period; and
in a case where a storage node of which the calculated load exceeds a threshold value is present, select scale-up of the storage node as the vertical scaling.

5. The scaling management apparatus according to claim 1, wherein the processor is further configured to select scale-out as the horizontal scaling in a case where a storage node in which a number of volumes added in a past predetermined period exceeds a predetermined threshold value is present.

6. The scaling management apparatus according to claim 5, wherein the past predetermined period is a period from previous selection of a scaling method or execution of scaling to a present time.

7. The scaling management apparatus according to claim 1, wherein
the storage system includes a plurality of redundant groups,
each of the plurality of redundant groups includes two or more storage nodes,
for each of the plurality of redundant groups, data stored in any storage node in the redundant group is made redundant between the storage nodes in the redundant group, and
in a case where a storage node in which a load of a component increased, decreased, increases, or decreases due to a fact that a load of an existing volume increased, decreased, increases, or decreases is present, the processor selects the vertical scaling for a redundant group including the storage node.

8. The scaling management apparatus according to claim 7, wherein
a plurality of zones that are physically independent from each other are present,
any storage node in each of the plurality of redundant groups belongs to each of the plurality of zones,
for each of the plurality of redundant groups, two or more storage nodes in the redundant group belong to two or more different zones among the plurality of zones, and
in a case where two or more redundant groups for which the vertical scaling is selected are present, the processor selects to perform the vertical scaling on two or more storage nodes belonging to a same zone in the two or more redundant groups in parallel.

9. A scaling management method for a storage system that includes one or a plurality of storage nodes each having a volume provided to a compute and a component that can affect performance of the volume, and in which a selected scaling method is performed, the scaling management method comprising:
causing a computer to refer to component load information and volume load information, the component load information indicating, for each of the one or the plurality of storage nodes, a load of a component included in the storage node, the volume load information indicating, for each of the one or plurality of storage nodes, a load of a volume included in the storage node;
in a case where the computer determines that a load of a component in any of the one or plurality of storage nodes increased, decreased, increases, or decreases due to a fact that a load of an existing volume in the storage node increased, decreased, increases, or decreases, causing the computer to select, as a scaling method for the storage system, vertical scaling for increasing or decreasing a resource allocated to the storage node having the component without increasing or decreasing a number of storage nodes of the storage system; and/or
in a case where the computer determines that a load of a component in any of the one or plurality of storage nodes increased, decreased, increases, or decreases due to a fact that a number of volumes of the storage node increased, decreased, increases, or decreases, causing the computer to select, as a scaling method for the storage system, horizontal scaling for increasing or decreasing the number of storage nodes of the storage system.

10. A computer program for causing a computer to:
refer to component load information and volume load information, the component load information relating to a storage system including one or a plurality of storage nodes each having a volume provided to a compute and a component that can affect performance of the volume, the component load information indicating, for each of the one or plurality of storage nodes, a load of a component included in the storage node, the volume load information indicating, for each of the one or the plurality of storage nodes, a load of a volume included in the storage node;
in a case where the computer determines that a load of a component in any of the one or plurality of storage nodes increased, decreased, increases, or decreases due to a fact that a load of an existing volume in the storage node increased, decreased, increases, or decreases, select, as a scaling method for the storage system, vertical scaling for increasing or decreasing a resource allocated to the storage node having the component without increasing or decreasing a number of storage nodes of the storage system; and
in a case where the computer determines that a load of a component in any of the one or plurality of storage nodes increased, decreased, increases, or decreases due to a fact that a number of volumes of the storage node increased, decreased, increases, or decreases, select, as a scaling method for the storage system, horizontal scaling for increasing or decreasing the number of storage nodes of the storage system.
